(19) United States
(12) Patent Application Publication
(10) Pub. No.: US 2023/0401426 A1
(43) Pub. Date: Dec. 14, 2023

(54) PREDICTION METHOD, PREDICTION APPARATUS AND PROGRAM

(71) Applicant: NIPPON TELEGRAPH AND TELEPHONE CORPORATION, Tokyo (JP)

(72) Inventors: Hideaki KIN, Tokyo (JP); Takeshi KURASHIMA, Tokyo (JP); Hiroyuki TODA, Tokyo (JP)

(21) Appl. No.: 18/248,760

(22) PCT Filed: Nov. 5, 2020
(86) PCT No.: PCT/JP2020/041385

§ 371 Date: Apr. 12, 2023

(51) Int. Cl. G06N 3/045; G06N 3/044

(52) U.S. Cl. CPC G06N 3/045; G06N 3/044

(57) ABSTRACT

A prediction method executed by a computer including a memory and a processor, the method includes: optimizing a parameter of a second function that outputs parameters of a first function from covariates, and optimizing a parameter of a kernel function of a Gaussian process, by using a series of observation values observed in a past and a series of the covariates observed simultaneously with the observation values, wherein values obtained by non-linearly transforming the observation values by the first function follow the Gaussian process; and calculating a prediction distribution of observation values in a period in future to be predicted by using the second function and the kernel function having parameters optimized in the optimizing, and a series of covariates in the period.

### TECHNICAL FIELD

The present invention relates to a prediction method, a prediction apparatus, and a program.

### BACKGROUND ART

Conventionally, techniques of outputting a prediction distribution of future one-dimensional continuous values on the basis of past history data have been known. Assuming that a time axis takes only integer values for time-series prediction (that is, prediction of continuous values at a plurality of future time points), each time is also referred to as a step or a time step, and continuous values to be predicted are also referred to as target values.

As a classical technique of time-series prediction, although autoregressive moving average models (ARIMA) have been known, in recent years, on the premise of using a large amount of history data, prediction techniques based on a more flexible model using neural networks are becoming mainstream. The prediction techniques using neural networks can be roughly classified into two types, a discriminative model method and a generative model method.

The discriminative model method is a method in which a length of the prediction period (that is, the period to be predicted) is determined in advance, past history data is taken as input, a probability distribution followed by a target value in a future prediction period is output, and an input and output relationship is constructed on the basis of a neural network. Meanwhile, the generative model method is a method in which history data from the past to the present is taken as input, a probability distribution followed by a target value at the next time step is output, and an input and output relationship is constructed on the basis of a neural network. In the generative model method, a target value one step ahead stochastically generated from a probability distribution that is an output of the neural network, is input again to the neural network as new history data, and a probability distribution one step ahead is obtained as an output thereof. In the prediction technique of the discriminative model method or the generative model method described above, it is common to take, as input, history data including not only past continuous values but also a simultaneously observable value (this value is also called a covariate).

As a prediction technique of the generative model method, for example, techniques disclosed in Non Patent Documents 1 to 3 have been known.

Non Patent Document 1 discloses that a past covariate and a target value predicted one step before are taken as input to a recurrent neural network (RNN), and a prediction distribution of a target value one step ahead is output.

Non Patent Document 2 discloses that, on the assumption that continuous values of a prediction target are temporally developed according to a linear state space model, a past covariate is taken as input of an RNN, and a parameter value on each time step in the state space model is output. In Non Patent Document 2, by inputting the target value predicted one step before to the state space model, a prediction distribution of the target value one step ahead is obtained as an output thereof.

Non Patent Document 3 discloses that, on the assumption that continuous values of a prediction target are temporally developed according to a Gaussian process, a past covariate is taken as input of an RNN, and a kernel function on each time step is output. In Non Patent Document 3, a joint prediction distribution of target values in a prediction period including a plurality of steps is obtained as an output of the Gaussian process.

### PRIOR ART DOCUMENTS

### Non Patent Documents

Non Patent Document 1: D. Salinas, et al., “DeepAR: Probabilistic forecasting with autoregressive recurrent networks”, International Journal of Forecasting, vol. 36, pp. 1181-1191 (2020).

Non Patent Document 2: S. Rangapuram, et al., “Deep state space models for time series forecasting”, Advances in Neural Information Processing Systems, pp. 7785-7794 (2018).

Non Patent Document 3: M. AI-Shedivat, et al., “Learning scalable deep kernels with recurrent structure”, Journal of Machine Learning Research, vol. 18, pp. 1-17.

### SUMMARY OF INVENTION

### Technical Problem to be Solved

However, conventional techniques of the generative model method have a high calculation cost or low prediction accuracy in some cases.

For example, in the technique disclosed in Non Patent Document 1, in order to obtain a target value one step ahead, it is necessary to perform Monte Carlo simulation on the basis of a prediction distribution output from an RNN when a target value predicted one step before is taken as input. Therefore, in order to obtain the target value of the prediction period including a plurality of steps, it is necessary to perform RNN calculation and Monte Carlo simulation the same number of times as the number of steps. In order to obtain the prediction distribution of the prediction period, it is necessary to obtain several hundreds to several thousand target values, and finally, it is necessary to perform RNN calculation and Monte Carlo simulation several hundred times to several thousand times the number of steps. In general, the calculation cost of the RNN calculation and the Monte Carlo simulation is high, and thus the calculation cost becomes enormous as the number of steps in the prediction period increases.

Meanwhile, for example, in the technique disclosed in Non Patent Document 2, the target value of the next time step is obtained from a linear state space model, and thus the calculation cost thereof is relatively small. However, due to a strong constraint that the prediction distribution is a normal distribution, there is a possibility that the prediction accuracy becomes low for complex time-series data. Similarly, for example, even in the technique disclosed in Non Patent Document 3, there is a possibility that the prediction accuracy becomes low for complicated time-series data due to a strong constraint that the prediction distribution is a normal distribution.

An embodiment of the present invention has been made in view of the above points, and has an object to achieve highly accurate time-series prediction even for complicated time-series data at a small calculation cost.

### Solution to Problem

In order to achieve the above object, according to an embodiment, a prediction method executed by a computer includes: an optimization step of optimizing a parameter of a second function that outputs parameters of a first function from covariates, and optimizing a parameter of a kernel function of a Gaussian process, by using a series of observation values observed in a past and a series of the covariates observed simultaneously with the observation values, wherein values obtained by non-linearly transforming the observation values by the first function follow the Gaussian process; and a prediction step of calculating a prediction distribution of observation values in a period in future to be predicted by using the second function and the kernel function having parameters optimized in the optimization step, and a series of covariates in the period.

### Advantageous Effects of Invention

It is possible to achieve highly accurate time-series prediction with a small calculation cost even for complicated time-series data.

### BRIEF DESCRIPTION OF DRAWINGS

FIG. 1 is a diagram illustrating an example of a hardware configuration of a time-series prediction apparatus according to a present embodiment.

FIG. 2 is a diagram illustrating an example of a functional configuration of the time-series prediction apparatus during parameter optimization time.

FIG. 3 is a flowchart illustrating an example of parameter optimization processing according to the present embodiment.

FIG. 4 is a diagram illustrating an example of a functional configuration of a time-series prediction apparatus during prediction time.

FIG. 5 is a flowchart illustrating an example of prediction processing according to the present embodiment.

### DESCRIPTION OF EMBODIMENTS

Hereinafter, one embodiment of the present invention will be described. In the present embodiment, a time-series prediction apparatus 10 capable of achieving highly accurate time-series prediction even for complicated time-series data with a small calculation cost for a prediction technique of a generative model method will be described. Here, regarding the time-series prediction apparatus 10 according to the present embodiment, there are a parameter optimization time during which various parameters (specifically, a parameter θ of a kernel function and a parameter v of an RNN, which will be described later) are optimized from time-series data (that is, history data) representing a past history, and a prediction time during which a value of a prediction distribution in a prediction period, a mean thereof, or the like is predicted.

### <Hardware Configuration>

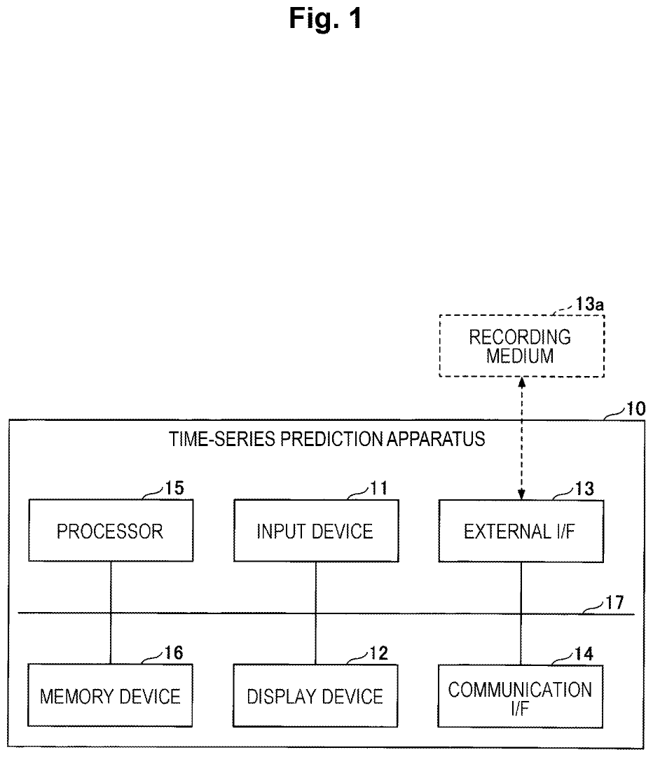

First, a hardware configuration of a time-series prediction apparatus 10 according to the present embodiment will be described with reference to FIG. 1. FIG. 1 is a diagram illustrating an example of the hardware configuration of the time-series prediction apparatus 10 according to the present embodiment. The hardware configuration of the time-series prediction apparatus 10 may be the same during the parameter optimization time and during the prediction time.

As illustrated in FIG. 1, the time-series prediction apparatus 10 according to the present embodiment is implemented by a hardware configuration of a general computer system, and includes an input device 11, a display device 12, an external I/F 13, a communication I/F 14, a processor 15, and a memory device 16 as the hardware. These pieces of hardware are communicably connected via a bus 17.

The input device 11 is, for example, a keyboard, a mouse, a touch panel, or the like. The display device 12 is, for example, a display or the like. Note that the time-series prediction apparatus 10 may not include at least one of the input device 11 and the display device 12, for example.

The external I/F 13 is an interface with an external device such as a recording medium 13a. The time-series prediction apparatus 10 can execute, for example, reading and writing on the recording medium 13a via the external I/F 13. Note that the recording medium 13a is, for example, a compact disc (CD), a digital versatile disk (DVD), a secure digital memory card (SD memory card), a Universal Serial Bus (USB) memory card, and the like.

The communication I/F 14 is an interface for connecting the time-series prediction apparatus 10 to a communication network. The processor 15 is, for example, an arithmetic/logic device of various types such as a central processing unit (CPU) and a graphics processing unit (GPU). The memory device 16 is, for example, a storage device of various types such as a hard disk drive (HDD), a solid state drive (SSD), a random access memory (RAM), a read-only memory (ROM), and a flash memory.

The time-series prediction apparatus 10 according to the present embodiment having the hardware configuration illustrated in FIG. 1 can implement various types of processing to be described later. Note that the hardware configuration illustrated in FIG. 1 is an example, and the time-series prediction apparatus 10 may have another hardware configuration. For example, the time-series prediction apparatus 10 may include a plurality of processors 15 or a plurality of memory devices 16.

### [During the Parameter Optimization Time]

Hereinafter, the time-series prediction apparatus 10 during the parameter optimization time will be described.

### <Functional Configuration>

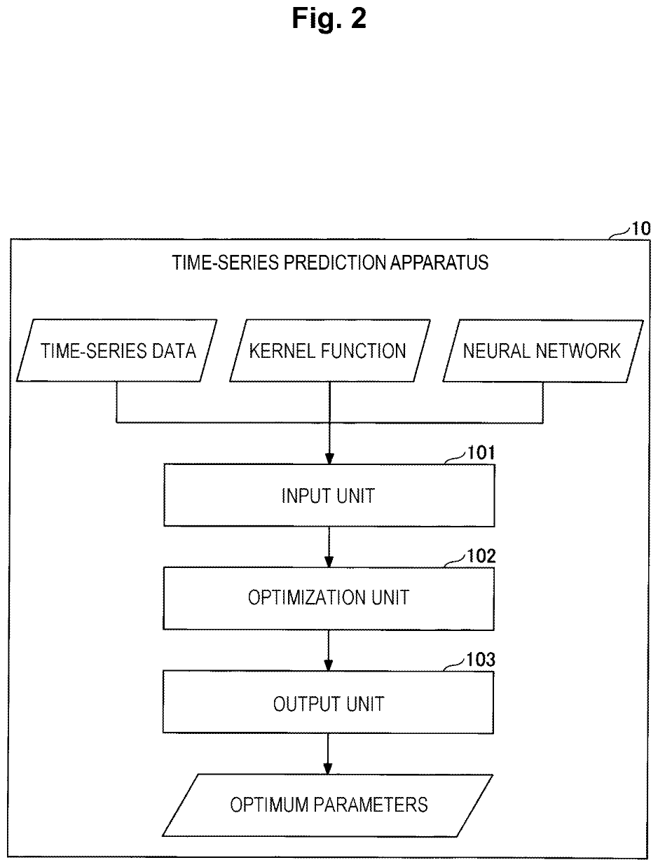

First, a functional configuration of the time-series prediction apparatus 10 during the parameter optimization time will be described with reference to FIG. 2. FIG. 2 is a diagram illustrating an example of a functional configuration of the time-series prediction apparatus 10 during the parameter optimization time.

As illustrated in FIG. 2, the time-series prediction apparatus 10 during the parameter optimization time includes an input unit 101, an optimization unit 102, and an output unit 103. Each of these units is implemented, for example, by processing executed by the processor 15 according to one or more programs installed in the time-series prediction apparatus 10.

The input unit 101 inputs time-series data, a kernel function, and a neural network provided to the time-series prediction apparatus 10. The time-series data, the kernel function, and the neural network are stored in, for example, the memory device 16 or the like.

The time series data is time-series data (that is, history data) representing past history, and includes a target value y_{1:T}={y₁, y₂, . . . , y_{T}} and a covariate x_{1:T}={x₁, x₂, . . . , x_{T}} from a time step t=1 to t=T. T is the number of time steps of the time-series data representing the past history. The target values and the covariates are assumed to take one-dimensional and multi-dimensional real values, respectively.

The target values are continuous values to be predicted, and examples thereof include the number of products sold in the marketing field, the blood pressure and blood glucose level of a person in the healthcare field, and power consumption in the infrastructure field. The covariate is a value that can be observed at the same time as the target value, and for example, in a case where the target value is the number of products sold, the day of the week, the month, the presence or absence of a sale, the season, the temperature, and the like may be exemplified.

The kernel function is a function that characterizes a Gaussian process and is denoted as k_{θ}(t, t′). The kernel function k_{θ}(t, t′) is a function that takes as input two time steps t and t′, and outputs a real value, and has a parameter θ. This parameter θ is not given as input, and is determined by the optimization unit 102 (that is, the parameter θ is a parameter to be optimized).

The neural network includes two types of neural networks Ω_{w,b}(•) and Ψᵥ(•).

Ω_{w,b}(•) is a forward propagation neural network configured only with an activation function that is a monotonically increasing function. It is assumed that parameters of the forward propagation neural network Ω_{w,b}(•) include a weight parameter w and a bias parameter b, and the dimensionality of each of the parameters is D_{w} and D_{b}. Examples of the activation function that is a monotonically increasing function include a sigmoid function, a soft plus function, a ReLU function, and the like.

Ψᵥ(•) is a recurrent neural network (RNN). It is assumed that the recurrent neural network Ψᵥ(•) has a parameter v, takes as input a covariate x_{1:t} up to a time step t, and outputs a two-dimensional real value (μₜ, φₜ), non-negative real values wₜ in the D_{w} dimensions, and real values bₜ in the D_{b} dimensions. That is, μₜ, φₜ, wₜ, bₜ=Ψᵥ (x_{1:t}) is assumed. This parameter v is not given as input, and is determined by the optimization unit 102 (that is, the parameter v is a parameter to be optimized). There are a plurality of types of recurrent neural networks such as a long short-term memory (LSTM) and a gated recurrent unit (GRU), and the type of recursive neural network to be used is specified in advance.

The optimization unit 102 uses the time-series data (target value y_{1:T}={y₁, y₂, . . . , y_{T}} and covariate x_{1:T}={x₁, x₂, . . . , x_{T}}) the kernel function k_{θ}(t, t′), the forward propagation neural network Ω_{w,b}(•), and the recurrent neural network Ψᵥ(•) to search for a parameter Θ=(θ, v) that minimizes a negative log marginal likelihood function. That is, the optimization unit 102 searches for a parameter Θ=(θ, v) that minimizes the following negative log marginal likelihood function L(Θ).

$$L ( Θ ) = \frac{1}{2} {z}^{⊤} {K}^{- 1} z + \frac{1}{2} log det ( K ) - {\sum }_{t = 1}^{T} log \vert {h}_{t} \vert + const \qquad [ Math . 1 ]$$

where, for 1≤t≤T,

$${z}_{t} = {Ω}_{{w}_{t} , {b}_{t}} ( {y}_{t} ) - {μ}_{t} \qquad [ Math . 2 ]$$

$${h}_{t} = \frac{d}{{dy}_{t}} {Ω}_{{w}_{t} , {b}_{t}} ( {y}_{t} )$$

$${μ}_{t} , {ϕ}_{t} , {w}_{t} , {b}_{t} = {Ψ}_{v} ( {x}_{1 : t} )$$

In addition, K=(K_{tt′}) is a T×T matrix, and

K_{tt′}=k_{θ}(ϕₜ,ϕ_{t′}), 1≤t,t′≤T [Math. 3]

Note that,

Z^{T} [Math. 4]
represents the transposition operation of the vertical vector z.

The output unit 103 outputs the parameter Θ optimized by the optimization unit 102 to any output destination. The optimized parameter Θ is also referred to as an optimum parameter, and represented as,

\hat{Θ}=(\hat{θ},\hat{v}) [Math. 5]

In the text of the specification, a hat “\hat{ }” indicating the optimized value is described immediately before the symbol, not immediately above the symbol. For example, the optimum parameter expressed in the above Math. 5 is expressed as \hat{ }Θ=(\hat{ }θ, \hat{ }v).

### <Parameter Optimization Processing>

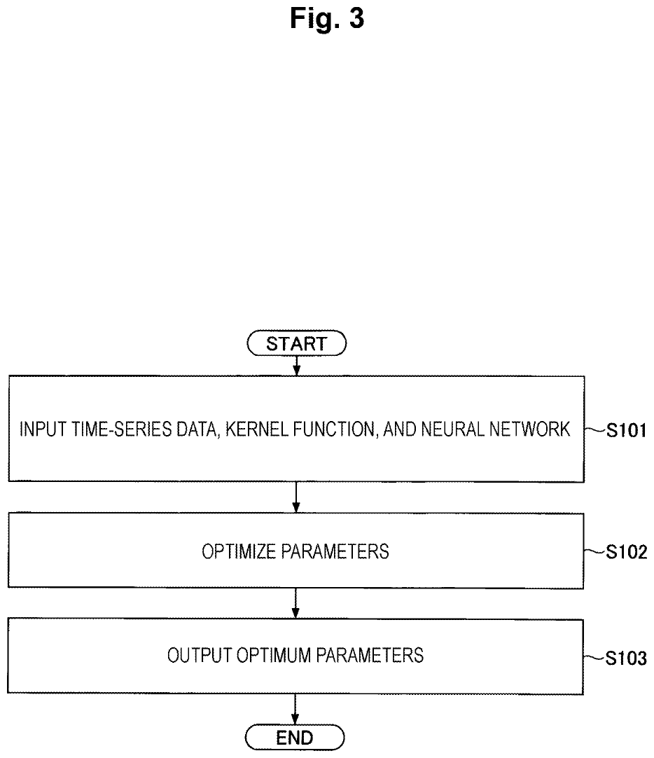

Next, parameter optimization processing according to the present embodiment will be described with reference to FIG. 3. FIG. 3 is a flowchart illustrating an example of the parameter optimization processing according to the present embodiment. It is assumed that the parameter Θ=(θ, v) is initialized by any initialization method.

Step S101: First, the input unit 101 takes as input the given time-series data (target value y_{1:T}={y₁, y₂, . . . , y_{T}} and covariate x_{1:T}={x₁, x₂, . . . , x_{T}}), the kernel function k_{θ}(t, t′), the neural network (forward propagation neural network Ω_{w,b}(•), and the recurrent neural network Ψᵥ(•))

Step S102: Next, the optimization unit 102 searches for a kernel function k_{θ}(t, t′) that minimizes the negative log marginal likelihood function L(Θ) shown in the Math. 1 described above and a parameter Θ=(θ, v) of the recurrent neural network Ψᵥ(•). It is sufficient that the optimization unit 102 searches for a parameter Θ=(θ, v) that minimizes the negative log marginal likelihood function L(Θ) shown in Math. 1 described above by any known optimization method.

Step S103: Then, the output unit 103 outputs the optimized parameter \hat{ }Θ to any output destination. The output destination of the optimum parameter \hat{ }θ may be, for example, the display device 12, the memory device 16, or the like, or may be another device or the like connected via the communication network.

### [During the Prediction Time]

Hereinafter, the time-series prediction apparatus 10 during the prediction time will be described.

### <Functional Configuration>

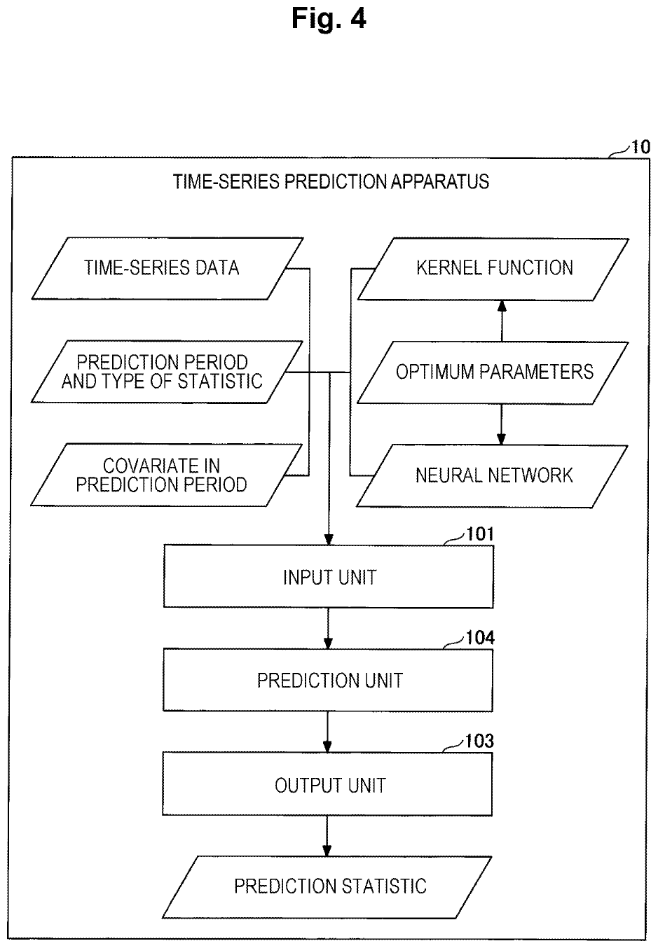

First, a functional configuration of the time-series prediction apparatus 10 during the prediction time will be described with reference to FIG. 4. FIG. 4 is a diagram illustrating an example of a functional configuration of the time-series prediction apparatus 10 during the prediction time.

As illustrated in FIG. 4, the time-series prediction apparatus 10 during the prediction time includes an input unit 101, a prediction unit 104, and an output unit 103. Each of these units is implemented, for example, by processing executed by the processor 15 according to one or more programs installed in the time-series prediction apparatus 10.

The input unit 101 inputs the time-series data, the prediction period and the type of statistic, the covariate in the prediction period, the kernel function, and the neural network provided to the time-series prediction apparatus 10. The time-series data, the covariate in the prediction period, the kernel function, and the neural network are stored in, for example, the memory device 16 or the like. Meanwhile, the prediction period and the type of statistic may be stored in, for example, the memory device 16 or the like, or may be specified by the user via the input device 11 or the like.

As in the parameter optimization time, the time-series data includes a target value y_{1:T}={y₁, y₂, . . . , y_{T}} and a covariate x_{1:T}={x₁, x₂, . . . , x_{T}} from a time step t=1 to t=T.

The prediction period is a period during which target values are predicted. Hereinafter, assuming that 1≤τ₀≤τ₁, t=T+τ₀, T+τ₀+1, . . . , T+τ₁ is set as the prediction period. Meanwhile, the type of statistic is the type of statistic of the target value to be predicted. Examples of the type of statistic include a value of a prediction distribution, a mean, a variance, and a quantile of the prediction distribution.

The covariate in the prediction period is a covariate in the prediction period t=T+τ₀, T+τ₀+1, . . . , T+τ₁, that is,

x_{T+τ}_{₀}_{:T+τ}_{₁}={x_{T+τ}_{₀}, . . . x_{T+τ}_{₁}}. [Math. 6]

The kernel function is a kernel function having an optimum parameter \hat{ }θ, that is,

k_{\hat{θ}}(t,t′) [Math. 7]

The neural network includes a forward propagation neural network Ω_{w,b}(•) and a recurrent neural network having an optimum parameter \hat{ }v

Ω_{\hat{v}}(⋅) [Math. 8]

The prediction unit 104 uses the kernel function k_{\hat{ }θ}(t, t′), the forward propagation neural network Ω_{w,b}(•), the recurrent neural network Ψ_{\hat{ }v}(•), and the covariate in the prediction period, to calculate a probability density distribution p(y*) of the target value vector in the prediction period

y*=(y_{T+τ}_{₀}, . . . ,y_{T+τ}_{₁})^{T} [Math. 9]

That is, the prediction unit 104 calculates the probability density distribution p(y*) as follows.

p(y*)= [symbol] (z*|E*,Σ*)Σ_{t=τ}_{₀}^{τ}^{₁}h_{T+t} [Math. 10]
where,

E*=k_{*}^{T}K⁻¹z

Σ*=K*−k_{*}^{T}K⁻¹k_{*} [Math. 11]
and for T+τ₀≤t≤T+τ₁,

μₜ,ϕₜ,wₜ,bₜ=Ψ_{\hat{v}}(x_{1:t})

zₜ*=Ω_{w}_{ₜ}_{,b}_{ₜ}(yₜ)−μₜ [Math. 12]

Further, for T+τ₀≤t, t′≤T+τ₁,

k_{*}=(k_{\hat{θ}}(t,t₁), . . . ,k_{\hat{θ}}(t,t_{T}))^{T}

K_{tt′}*=k_{\hat{θ}(ϕ}ₜ,ϕ_{t′}) [Math. 13]

Note that K*=(K_{tt′}*).

However,

[symbol]

(⋅|E,Σ) [Math. 14]
denotes the multivariate normal distribution of mean E and covariance Σ.

Then, the prediction unit 104 calculates the statistic of the target value by using the probability density distribution p(y*). A method of calculating the target value according to the type of statistic will be described below.

Value of Prediction Distribution

With the probability density distribution p(y*), a probability corresponding to the target value yₜ at any time step in the prediction period can be obtained without using Monte Carlo simulation.

Quantile of Prediction Distribution

A quantile Q_{y} of the prediction distribution of the target value yₜ is obtained by calculating a quantile Q_{z} of zₜ* following a normal distribution, and then, converting Q_{z} by the following formula.

Q_{y}=Ω_{w}_{ₜ}_{,b}_{ₜ}⁻¹(Q_{z}+μₜ) [Math. 15]

where,

Ω_{w}_{ₜ}_{,b}_{ₜ}⁻¹(⋅) [Math. 16]
is the inverse function of the following monotonically increasing function,

Ω_{w}_{ₜ}_{,b}_{ₜ}(⋅) [Math. 17]

For the above Math. 15, it possible to obtain its solution by a simple root-finding algorithm such as the bisection method thanks to its monotonic increasing property, and it is not necessary to use Monte Carlo simulation.

Expected Value of Function

The expected value of the function f(y*) generally depending on y*, including the mean or covariance of each element yₜ(T+τ₀≤t≤T+τ₁) of the target value vector y* in the prediction period, is calculated by the following formula using Monte Carlo simulation.

$$E [ f ( {y}^{*} ) ] = \frac{1}{J} {\sum }_{j = 1}^{J} f ( {\overline{y}}^{j} ) \qquad [ Math . 18 ]$$

$$where ,$$

$${\overline{y}}^{j} \qquad [ Math . 19 ]$$

represents a result obtained in a j-th Monte Carlo simulation based on the probability density distribution p(y*). The Monte Carlo simulation based on the probability density distribution p(y*) is performed by the following two steps (1) and (2).

(1) Multivariate Normal Distribution

From

[symbol]

(z*|E*,Σ*) [Math. 20]

J Samples

{z̅¹,z̅², . . . ,z̅^{J}} [Math. 21]
are generated.

(2) The Samples Generated in the Above (1) is Converted by the Following Formula.

y̅ₜ^{j}=Ω_{w}_{ₜ}_{,b}_{ₜ}⁻¹(z̅ₜ^{j}+μₜ),T+τ₀≤t≤T+τ₁ [Math. 22]

As a result,

y̅^{j}=(y̅_{T+τ}_{₀}^{j}, . . . ,y̅_{T+τ}_{₁}^{j})^{T} [Math. 23]
is obtained.

The output unit 103 outputs the statistic (hereinafter, also referred to as a prediction statistic) predicted by the prediction unit 104 to any output destination.

### <Prediction Processing>

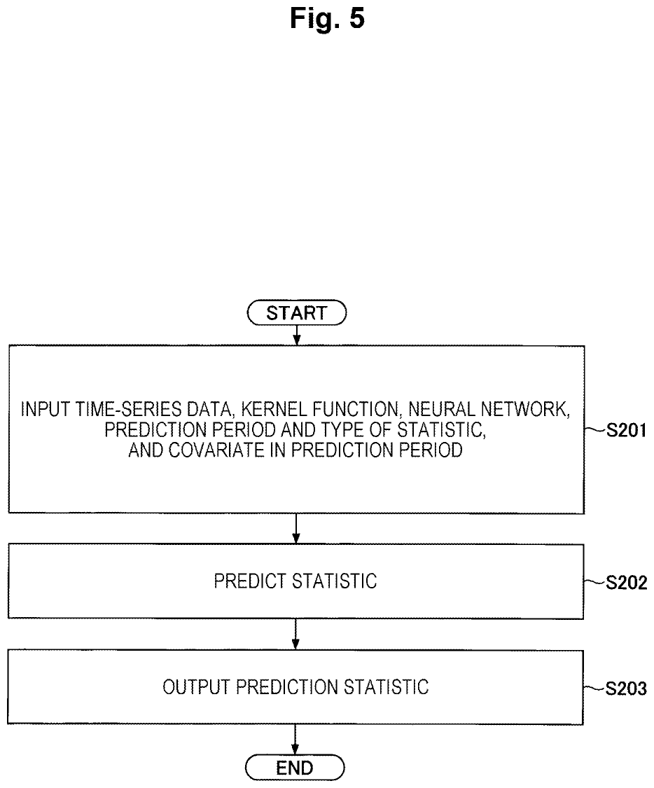

Next, prediction processing according to the present embodiment will be described with reference to FIG. 5. FIG. 5 is a flowchart illustrating an example of prediction processing according to the present embodiment.

Step S201: First, the input unit 101 takes as input the given time-series data (target value y_{1:T}={y₁, y₂, . . . , y_{T}} and covariate x_{1:T}={x₁, x₂, . . . , x_{T}}), the prediction period t=T+τ₀, T+τ₀+1, . . . , T+τ₁, the type of statistic to be predicted, the covariate {xₜ}(t=T+τ₀, T+τ₀+1, . . . , T+τ₁) of the prediction period, the kernel function k_{\hat{ }θ}(t, t′), and the neural network (forward propagation neural network Ω_{w,b}(•) and recurrent neural network Ψ_{\hat{ }v}(•)).

Step S202: Next, the prediction unit 104 calculates the probability density distribution p(y) by the above Math. 10, and then, calculates the prediction statistic according to the type of statistic to be predicted.

Step S203: Then, the output unit 103 outputs the prediction statistic to any output destination. The output destination of the prediction statistic may be, for example, the display device 12, the memory device 16, or the like, or may be another device or the like connected via the communication network.

### CONCLUSION

As described above, the time-series prediction apparatus 10 according to the present embodiment converts the target value yₜ (in other words, the observed target value yₜ) representing the past history by the nonlinear function Ω_{w,b}(•), and performs prediction on the assumption that the converted value Ω_{w,b}(yₜ) follows the Gaussian process. In this respect, the present embodiment is a generalization of the technique disclosed in Non Patent Document 3, and considering a special case of the identity function being Ω_{w,b}(yₜ)=yₜ, the present embodiment is consistent with the technique disclosed in Non Patent Document 3.

In the present embodiment, by maintaining the weight parameter w=wₜ to be a non-negative value, it can be ensured that Ω_{w,b}(•) is a monotonically increasing function. Thanks to this monotonically increasing property, the calculation cost of the prediction processing by the prediction unit 104 can be reduced.

Therefore, the time-series prediction apparatus 10 according to the present embodiment can achieve highly accurate time-series prediction even for more complicated time-series data under the same calculation cost as the technique disclosed in Non Patent Document 3.

In the present embodiment, the time-series prediction apparatus 10 during the parameter optimization time and the time-series prediction apparatus 10 during the prediction time are implemented as the same device, but the present invention is not limited to this, and may be implemented as separate devices.

The present invention is not limited to the above-mentioned specifically disclosed embodiment, and various modifications and changes, combinations with known techniques, and the like can be made without departing from the scope of the claims.

### REFERENCE SIGNS LIST

10 Time-series prediction apparatus
11 Input device
12 Display device
13 External I/F
13a Recording medium
14 Communication I/F
15 Processor
16 Memory device
17 Bus
101 Input unit
102 Optimization unit
103 Output unit
104 Prediction unit

1. A prediction method executed by a computer including a memory and a processor, the method comprising:
optimizing a parameter of a second function that outputs parameters of a first function from covariates, and optimizing a parameter of a kernel function of a Gaussian process, by using a series of observation values observed in a past and a series of the covariates observed simultaneously with the observation values, wherein values obtained by non-linearly transforming the observation values by the first function follow the Gaussian process; and
calculating a prediction distribution of observation values in a period in future to be predicted by using the second function and the kernel function having parameters optimized in the optimizing, and a series of covariates in the period.

2. The prediction method according to claim 1, the method further comprising:
calculating a statistic of the observation values in the period by using the calculated prediction distribution.

3. The prediction method according to claim 1, wherein the first function is a forward propagation neural network having a weight and a bias as parameters and a monotonically increasing function as an activation function, and
the second function is a recurrent neural network that outputs at least the weight of a non-negative value and the bias.

4. The prediction method according to claim 3, wherein the second function further outputs a real value to be taken as input of the kernel function.

5. The prediction method according to claim 1,
wherein, in the optimizing, the parameters of the second function and the kernel function are optimized by searching for parameters of the second function and the kernel function that minimize negative log marginal likelihood.

6. A prediction apparatus comprising:
a memory; and
a processor configured to execute:
optimizing a parameter of a second function that outputs parameters of a first function from covariates and optimizes a parameter of a kernel function of a Gaussian process, by using a series of observation values observed in a past and a series of the covariates observed simultaneously with the observation values, wherein values obtained by non-linearly transforming the observation values by the first function follow the Gaussian process; and
calculating a prediction distribution of observation values in a period in future to be predicted by using the second function and the kernel function having parameters optimized in the optimizing and a series of covariates in the period.

7. A non-transitory computer-readable recording medium having computer-readable instructions stored thereon, which when executed, cause a computer to perform the prediction method according to claim 1.
